(19) United States
(12) Patent Application Publication
(10) Pub. No.: US 2016/0282675 A1
(43) Pub. Date: Sep. 29, 2016

(54) THIN FILM TRANSISTOR SUBSTRATE AND LIQUID CRYSTAL DISPLAY PANEL

(71) Applicant: SHEN-ZHEN CHINA STAR OPTOELECTRONICS TECH NOLOGY CO., LTD., Shenzhen, Guangdong (CN)

(72) Inventors: Houbin Li, Guangdong (CN); Yu-Wu Huang, Guangdong (CN)

(21) Appl. No.: 14/410,429

(22) PCT Filed: Aug. 8, 2014
(86) PCT No.: PCT/CN2014/084040

§ 371 Date: Dec. 22, 2014

(30) Foreign Application Priority Data
Jul. 29, 2014 (CN) 201410366182.4

(51) Int. Cl. G02F 1/1337; G02F 1/1362; G02F 1/1368

(52) U.S. Cl. CPC G02F 1/133723; G02F 1/1368; G02F 1/136286; G02F 2001/136295

(57) ABSTRACT

An array substrate and a liquid crystal display panel are proposed. The array substrate includes a data line, a scan line, a pixel electrode, a thin film transistor, a common line and an alignment film. The common line is a grid-shaped wire. By using the common line with a grid-shaped pattern, the present invention effectively prevents the alignment film from being accumulated on the periphery of the array substrate.

### BACKGROUND OF THE INVENTION

1. Field of the Invention

The present invention relates to the field of liquid crystal technology, and more particularly, to a thin film transistor (TFT) substrate and a liquid crystal display panel.

2. Description of the Prior Art

Technology on liquid crystal display (LCD) improves. More and more people are used to socializing or communicating with others through the LCDs.

Any conventional LCD panel in any conventional LCD comprises an array substrate and a color filter (CF) substrate. A liquid crystal layer is disposed between the array substrate and the CF substrate. A polyimide (PI) alignment film is coated on an inner side of the array substrate and an inner side of the CF substrate for forcing liquid crystal molecules in the liquid crystal layer to form a tilt angle. The response speed of the LCD is improved accordingly.

When the PI alignment film is coated on the array substrate, the material forming the PI alignment film is spread all around the array substrate. Since the peripheral structure (outer cabling section) of the array substrate is different from that of the inner display section, it easily causes the material forming the PI alignment film to accumulate on the periphery of the array substrate. The thickness of the PI alignment film on the neighboring display sections tends to become a bit obvious as well. When the LCD works, light is easy to leak from the periphery of the LCD panel (or leak from the periphery of the array substrate). It shows that the display quality of the LCD is negatively affectively.

Therefore, it is necessary to fabricate a new array substrate and a new LCD panel to solve the technological problem occurring in the conventional technology.

### SUMMARY OF THE INVENTION

An object of the present invention is to provide an array substrate and an LCD panel to solve the problem occurring in the conventional technology. The technological problem is that the alignment film is easily accumulated on the periphery of the array substrate in the conventional LCD panel, which easily causes light to be leaked from the periphery of the conventional LCD panel.

According to a preferred embodiment of the present invention, an array substrate disposed in a corresponding liquid crystal display (LCD) panel is provided. The array substrate comprises:

a data line, for transmitting a data signal;

a scan line, for transmitting a scan signal;

a pixel electrode, for receiving the data signal;

a thin film transistor (TFT), for transmitting the data signal to the pixel electrode according to the scan signal;

a common line, being a grid-shaped wire, for transmitting a common signal; and an alignment film, disposed on a surface of the array substrate, for forcing liquid crystal molecules to form a tilt angle;

the data line, the scan line, the pixel electrode, and the TFT disposed in a display section in a middle area of the array substrate, the common line disposed in a non-display section on the periphery of the array substrate, and the alignment film disposed in the display and non-display sections;

wherein the common line is made of aluminum (Al), and a thickness of the common line is 80 to 200 nanometers (nm).

In the array substrate of the present invention, a width of the common line is 400 to 600 micrometers (μm).

In the array substrate of the present invention, a width of the grid formed by the common line is 4 μm to 10 μm.

In the array substrate of the present invention, a thickness of the alignment film is 100 nm to 200 nm.

In the array substrate of the present invention, the thickness of the alignment film in the non-display section of the array substrate is 150 nm to 200 nm.

In the array substrate of the present invention, the thickness of the alignment film in the display section of the array substrate is 100 nm to 150 nm.

According to another preferred embodiment of the present invention, an array substrate disposed in a corresponding liquid crystal display (LCD) panel is provided. The array substrate comprises:

a data line, for transmitting a data signal;

a scan line, for transmitting a scan signal;

a pixel electrode, for receiving the data signal;

a thin film transistor (TFT), for transmitting the data signal to the pixel electrode according to the scan signal;

a common line, being a grid-shaped wire, for transmitting a common signal; and an alignment film, disposed on a surface of the array substrate, for forcing liquid crystal molecules to form a tilt angle;

the data line, the scan line, the pixel electrode, and the TFT disposed in a display section in a middle area of the array substrate, the common line disposed in a non-display section on the periphery of the array substrate, and the alignment film disposed in the display and non-display sections.

In the array substrate of the present invention, a width of the common line is 400 to 600 micrometers (μm).

In the array substrate of the present invention, a width of the grid formed by the common line is 4 μm to 10 μm.

In the array substrate of the present invention, the common line is made of aluminum (Al).

In the array substrate of the present invention, a thickness of the common line is 80 to 200 nanometers (nm).

In the array substrate of the present invention, a thickness of the alignment film is 100 nm to 200 nm.

In the array substrate of the present invention, the thickness of the alignment film in the non-display section of the array substrate is 150 nm to 200 nm.

In the array substrate of the present invention, the thickness of the alignment film in the display section of the array substrate is 100 nm to 150 nm.

According to another preferred embodiment of the present invention, a liquid crystal display (LCD) panel comprising an array substrate, a color filter substrate and a liquid crystal layer therebetween is provided. The array substrate comprises:

a data line, for transmitting a data signal;

a scan line, for transmitting a scan signal;

a pixel electrode, for receiving the data signal;

a thin film transistor (TFT), for transmitting the data signal to the pixel electrode according to the scan signal;

a common line, being a grid-shaped wire, for transmitting a common signal; and

an alignment film, disposed on a surface of the array substrate, for forcing liquid crystal molecules to form a tilt angle;

the data line, the scan line, the pixel electrode, and the TFT disposed in a display section in a middle area of the array substrate, the common line disposed in a non-display section on the periphery of the array substrate, and the alignment film disposed in the display and non-display sections.

In the LCD panel of the present invention, a width of the common line is 400 to 600 micrometers (μm).

In the LCD panel of the present invention, a width of the grid formed by the common line is 4 μm to 10 μm.

In the LCD panel of the present invention, the common line is made of aluminum (Al).

In the LCD panel of the present invention, a thickness of the common line is 80 to 200 nanometers (nm).

In the LCD panel of the present invention, a thickness of the alignment film is 100 nm to 200 nm.

Compared with the conventional array substrate and the conventional LCD panel, the array substrate and the LCD panel provided by the present invention comprise a common line with a grid-shaped pattern. The common line effectively prevents the alignment film from being accumulated on the periphery of the array substrate. In other words, the technological problems that the accumulation of the alignment film on the periphery of the conventional array substrate and light leakage from the periphery of the conventional LCD panel will be successfully solved if the present invention is adopted.

These and other features, aspects and advantages of the present disclosure will become understood with reference to the following description, appended claims and accompanying figures.

### BRIEF DESCRIPTION OF THE DRAWINGS

FIG. 1 is a schematic diagram showing the structure of an array substrate in a conventional technology.

FIG. 2 is a cross section of a conventional LCD panel where the conventional array substrate is disposed according to an A-A′ section line in FIG. 1.

FIG. 3 is a schematic diagram showing the structure of an array substrate according to a preferred embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

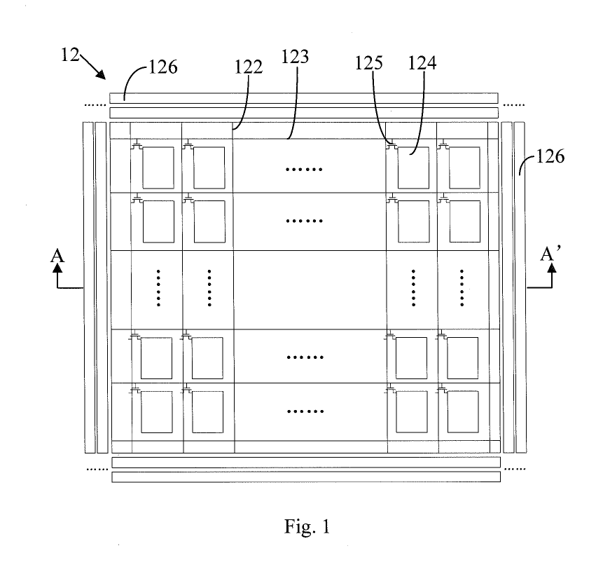

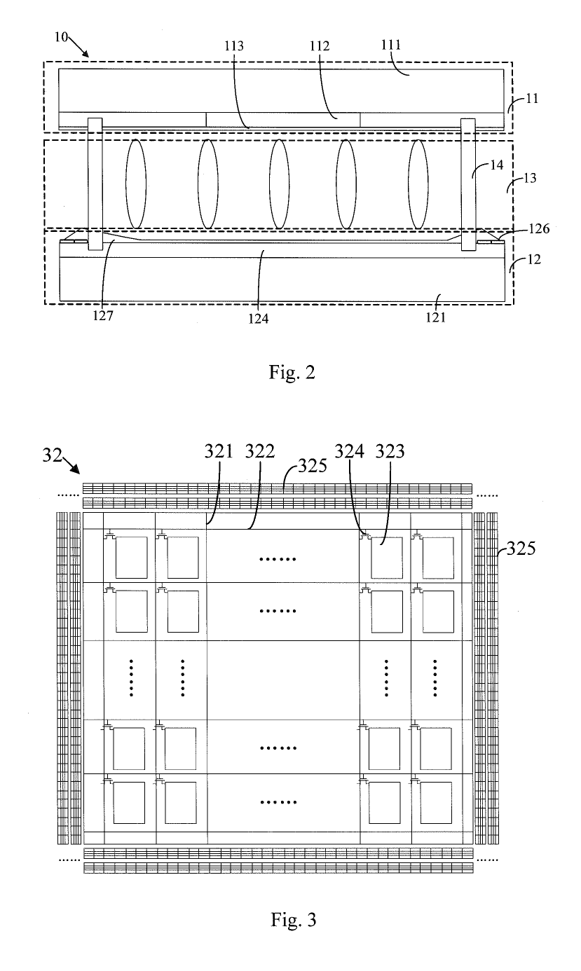

It is noted that the same components are labeled by the same number. Please refer to FIG. 1 and FIG. 2. FIG. 1 is a schematic diagram showing the structure of an array substrate in a conventional technology. FIG. 2 is a cross section of a conventional LCD panel 10 where the conventional array substrate is disposed according to an A-A′ section line in FIG. 1. To facilitate description, the size of some of the components in FIG. 1 and FIG. 2 is correspondingly changed. Some components in the conventional technology are not improved, and they do not show up in FIG. 1 and FIG. 2.

The LCD panel 10 comprises a color filter (CF) substrate 11, an array substrate 12, and a liquid crystal layer 13. The liquid crystal layer 13 is disposed between the array substrate 12 and the CF substrate 11. The array substrate 12 comprises an array substrate base 121, a data line 122, a scan line 123, a pixel electrode 124, a TFT 125, a common line 126, and an array substrate alignment film 127. The CF substrate 11 comprises a CF substrate base 111, a diverse color resistant 112, and a color film alignment film 113. The liquid crystal layer 13 is kept tightly in an accommodation between the array substrate 12 and the CF substrate 11 with a sealant 14. The data line 122 is used for transmitting a data signal. The scan line 123 is used for transmitting a scan signal. The pixel electrode 124 is used for receiving the data signal. The TFT 125 is used for transmitting the data signal to the pixel electrode 124 according to the scan signal. The common line 126, which may be a solid wire or a solid thin film line, is used for transmitting a common signal. The array substrate alignment film 127 is disposed on the surface of the array substrate and used for forcing liquid crystal molecules in the liquid crystal layer 13 to form a tilt angle.

The data line 122, the scan line 123, the pixel electrode 124, and the TFT 125 are disposed in the display section in the middle area of the array substrate 12. The common line 126 is disposed in a non-display section on the periphery of the array substrate 12. The array substrate alignment film 127 is disposed in the display and non-display sections of the array substrate 12. (And the array substrate alignment film 127 is disposed on the array substrate 12 entirely.)

Please refer to FIG. 1 and FIG. 2 showing the manufacturing of the conventional array substrate 12. At first, the data line 122, the scan line 123, the TFT 125, the pixel electrode 124, and the common line 126 are formed on the array substrate base 121. Next, the array substrate alignment film 127 (i.e., a PI alignment film) is coated on the surface of the whole array substrate 12. The common line 126, which is a solid wire, is disposed on the periphery of the array substrate 12. The array substrate alignment film 127 is hard to spread on the array substrate 12 because of the block of the common line 126. Thus, the array substrate alignment film 127 on the periphery of the array substrate 12 is a bit thicker. The array substrate alignment films 127 on the neighboring display sections are a bit thicker as well, about 200 to 300 nanometers (nm). As a result, the periphery of the LCD panel 10 tends to leak light, which affect the display quality of the LCD.

Please refer to FIG. 3. FIG. 3 is a schematic diagram showing the structure of an array substrate 32 according to a preferred embodiment of the present invention. The array substrate 32 comprises an array substrate base (not shown in FIG. 3), a data line 321, a scan line 322, a pixel electrode 323, a TFT 324, a common line 325, and an alignment film (not shown in FIG. 3). The data line 321 is used for transmitting a data signal. The scan line 322 is used for transmitting a scan signal. The pixel electrode 323 is used for receiving the data signal. The TFT 324 is used for transmitting the data signal to the pixel electrode 323 according to the scan signal. The common line 325 with a grid-shaped pattern is used for transmitting a common signal. The common line 325 is a wire. The alignment film is disposed on the surface of the array substrate 32 and used for forcing the liquid crystal molecules to form a tilt angle.

The data line 321, the scan line 322, the pixel electrode 323, and the TFT 324 are disposed in the display section in the middle area of the array substrate 32. The common line 325 is disposed in a non-display section on the periphery of the array substrate 32. The alignment film is disposed in the display and non-display sections of the array substrate 32.

Please refer to FIG. 3 showing the manufacturing of the array substrate 32 proposed by the preferred embodiment of the present invention. At first, the data line 321, the scan line 322, the TFT 324, the pixel electrode 323, and the common line 325 are formed on the array substrate base of the array substrate 32. Next, an alignment film (i.e., a PI alignment film) is coated on the surface of the whole array substrate 32. The alignment film is spread to a section of the array substrate 32 where the common line 325 is disposed. It is easier for the alignment film to spread since the common line 325 is a grid-shaped wire. In this way, the alignment film on the periphery of the array substrate 32 (non-display section) is not very thick. The difference between the thickness of the alignment films on the neighboring display sections and the thickness of the alignment film in the display section on the middle area of the array substrate 32 is smaller. So, light does be leaked from the periphery of the LCD panel, which improves the display quality of the LCD.

Preferably, the common line 325 on the array substrate 32 is made of aluminum (Al). The width of the common line 325 is 400 to 600 micrometers (μm). The width of the grid-shaped common line 325 is 4 μm to 10 μm. (The particles of a frequently-used alignment film are all smaller than the size of the grid.) The thickness of the common line 325 is 80 to 120 nanometers (nm). Thus, the thickness of the alignment film in the non-display section (a section where the common line 325 is disposed) on the periphery of the array substrate 32 is 150 nm to 200 nm. The thickness of the alignment film in the display section in the middle area of the array substrate 32 is 100 nm to 150 nm. (The thickness of the alignment film in the non-display section of the conventional array substrate is 200 nm to 300 nm.) In this way, the difference between the thickness of the alignment film on the periphery of the display section of the array substrate 32 and the thickness of the alignment film in the middle area of the display section of the array substrate 32 becomes less obvious. No light is leaked from the periphery of the LCD panel. Owing to the revision, the display quality of the LCD is improved.

The present invention also proposes a liquid crystal display (LCD) panel comprising an array substrate, a color filter substrate and a liquid crystal layer therebetween. The array substrate comprises a data line for transmitting a data signal, a scan line for transmitting a scan signal, a pixel electrode for receiving the data signal, a thin film transistor (TFT) for transmitting the data signal to the pixel electrode according to the scan signal, a common line which is a grid-shaped wire and is used for transmitting a common signal, and an alignment film, disposed on a surface of the array substrate, for forcing liquid crystal molecules to form a tilt angle.

The data line, the scan line, the pixel electrode, and the TFT are disposed in the display section in the middle area of the array substrate. The common line is disposed in the non-display section on the periphery of the array substrate. The alignment film is disposed in the display section and the non-display section of the array substrate. The implementation of the LCD panel provided by the present invention can refer to the implementation of the array substrate introduced in the preferred embodiment as mentioned above since their working principles are the same or very similar.

Owing to the disposition of the common line with the grid-shaped pattern on the LCD panel, the alignment film is effectively prevented from being accumulated on the periphery of the array substrate in the present invention. In other words, the technological problems that the accumulation of the alignment film on the periphery of the conventional array substrate and light leakage from the periphery of the conventional LCD panel are successfully solved.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. An array substrate, disposed in a corresponding liquid crystal display (LCD) panel, comprising:
a data line, for transmitting a data signal;
a scan line, for transmitting a scan signal;
a pixel electrode, for receiving the data signal;
a thin film transistor (TFT), for transmitting the data signal to the pixel electrode according to the scan signal;
a common line, being a grid-shaped wire, for transmitting a common signal; and
an alignment film, disposed on a surface of the array substrate, for forcing liquid crystal molecules to form a tilt angle;
the data line, the scan line, the pixel electrode, and the TFT disposed in a display section in a middle area of the array substrate, the common line disposed in a non-display section on the periphery of the array substrate, and the alignment film disposed in the display and non-display sections;
wherein the common line is made of aluminum (Al), and a thickness of the common line is 80 to 200 nanometers (nm).

2. The array substrate as claimed in claim 1, wherein a width of the common line is 400 to 600 micrometers (μm).

3. The array substrate as claimed in claim 1, wherein a width of the grid formed by the common line is 4 μm to 10 μm.

4. The array substrate as claimed in claim 1, wherein a thickness of the alignment film is 100 nm to 200 nm.

5. The array substrate as claimed in claim 4, wherein the thickness of the alignment film in the non-display section of the array substrate is 150 nm to 200 nm.

6. The array substrate as claimed in claim 4, wherein the thickness of the alignment film in the display section of the array substrate is 100 nm to 150 nm.

7. An array substrate, disposed in a corresponding liquid crystal display (LCD) panel, comprising:
a data line, for transmitting a data signal;
a scan line, for transmitting a scan signal;
a pixel electrode, for receiving the data signal;
a thin film transistor (TFT), for transmitting the data signal to the pixel electrode according to the scan signal;
a common line, being a grid-shaped wire, for transmitting a common signal; and
an alignment film, disposed on a surface of the array substrate, for forcing liquid crystal molecules to form a tilt angle;
the data line, the scan line, the pixel electrode, and the TFT disposed in a display section in a middle area of the array substrate, the common line disposed in a non-display section on the periphery of the array substrate, and the alignment film disposed in the display and non-display sections.

8. The array substrate as claimed in claim 7, wherein a width of the common line is 400 to 600 micrometers (μm).

9. The array substrate as claimed in claim 7, wherein a width of the grid formed by the common line is 4 μm to 10 μm.

10. The array substrate as claimed in claim 7, wherein the common line is made of aluminum (Al).

11. The array substrate as claimed in claim 7, wherein a thickness of the common line is 80 to 200 nanometers (nm).

12. The array substrate as claimed in claim 7, wherein a thickness of the alignment film is 100 nm to 200 nm.

13. The array substrate as claimed in claim 12, wherein the thickness of the alignment film in the non-display section of the array substrate is 150 nm to 200 nm.

14. The array substrate as claimed in claim 12, wherein the thickness of the alignment film in the display section of the array substrate is 100 nm to 150 nm.

15. A liquid crystal display (LCD) panel comprising an array substrate, a color filter substrate and a liquid crystal layer therebetween, the array substrate comprising:
a data line, for transmitting a data signal;
a scan line, for transmitting a scan signal;
a pixel electrode, for receiving the data signal;
a thin film transistor (TFT), for transmitting the data signal to the pixel electrode according to the scan signal;
a common line, being a grid-shaped wire, for transmitting a common signal; and
an alignment film, disposed on a surface of the array substrate, for forcing liquid crystal molecules to form a tilt angle;
the data line, the scan line, the pixel electrode, and the TFT disposed in a display section in a middle area of the array substrate, the common line disposed in a non-display section on the periphery of the array substrate, and the alignment film disposed in the display and non-display sections.

16. The LCD panel as claimed in claim 15, wherein a width of the common line is 400 to 600 micrometers (μm).

17. The LCD panel as claimed in claim 15, wherein a width of the grid formed by the common line is 4 μm to 10 μm.

18. The LCD panel as claimed in claim 15, wherein the common line is made of aluminum (Al).

19. The LCD panel as claimed in claim 15, wherein a thickness of the common line is 80 to 200 nanometers (nm).

20. The LCD panel as claimed in claim 15, wherein a thickness of the alignment film is 100 nm to 200 nm.
